(19) United States
(12) Patent Application Publication
(10) Pub. No.: US 2022/0414464 A1
(43) Pub. Date: Dec. 29, 2022

(54) METHOD AND SERVER FOR FEDERATED MACHINE LEARNING

(71) Applicant: Agency for Science, Technology and Research, Singapore (SG)

(72) Inventors: Pavitra Krishnaswamy, Singapore (SG); Lakshminarayanan Anantharaman, Singapore (SG); Feri Guretno, Singapore (SG); Mien Ho, Singapore (SG)

(21) Appl. No.: 17/777,960

(22) PCT Filed: Dec. 10, 2019
(86) PCT No.: PCT/SG2019/050608

§ 371 Date: May 18, 2022

(51) Int. Cl. G06N 3/08; G06N 3/04; G06F 9/54

(52) U.S. Cl. CPC G06N 3/08; G06N 3/0454; G06F 9/54

(57) ABSTRACT

There is provided a method of federated machine learning using at least one processor, the method including: transmitting a current global machine learning model to each of a plurality of data sources; receiving a plurality of training updates from the plurality of data sources, respectively, each of the plurality of training updates being generated by the respective data source in response to the global machine learning model received; and updating the current global machine learning model based on the plurality of training updates received and a plurality of data quality parameters associated with the plurality of data sources, respectively, to generate an updated global machine learning model. There is also provided a corresponding server for federated machine learning.

### TECHNICAL FIELD

The present invention generally relates to a method of federated machine learning, and a server thereof.

### BACKGROUND

Supervised deep learning algorithms offer state-of-the-art performance for a variety of classification tasks, such as image classification tasks. A conventional approach for these tasks may comprise three steps: (a) centralize a large data repository, (b) acquire ground truth annotations for these data, and (c) employ the ground truth annotations to train convolutional neural networks (CNNs) for classification. However, this framework poses significant practical challenges.

In particular, data privacy and security concerns pose difficulties in creating large central data repositories for training. Recent works have developed decentralized federated learning approaches to train deep learning models across multiple data sources without sharing sensitive information. These existing federated learning approaches have had demonstrated successes, but may nevertheless suffer from inaccuracies and/or unreliability depending on the data sources on which they are trained.

A need therefore exists to provide a method of federated machine learning, and a system thereof, that seek to overcome, or at least ameliorate, one or more of the deficiencies in existing federated machine learning approaches or methods, such as but not limited to, improving the accuracy and/or reliability of federated machine learning. It is against this background that the present invention has been developed.

### SUMMARY

According to a first aspect of the present invention, there is provided a method of federated machine learning using at least one processor, the method comprising:

transmitting a current global machine learning model to each of a plurality of data sources;

receiving a plurality of training updates from the plurality of data sources, respectively, each of the plurality of training updates being generated by the respective data source in response to the global machine learning model received; and

updating the current global machine learning model based on the plurality of training updates received and a plurality of data quality parameters associated with the plurality of data sources, respectively, to generate an updated global machine learning model.

According to a second aspect of the present invention, there is provided a server for federated machine learning comprising:

a memory; and

at least one processor communicatively coupled to the memory and configured to:

transmit a current global machine learning model to each of a plurality of data sources;

receive a plurality of training updates from the plurality of data sources, respectively, each of the plurality of training updates being generated by the respective data source in response to the global machine learning model received; and

update the current global machine learning model based on the plurality of training updates received and a plurality of data quality parameters associated with the plurality of data sources, respectively, to generate an updated global machine learning model.

According to a third aspect of the present invention, there is provided a computer program product, embodied in one or more non-transitory computer-readable storage mediums, comprising instructions executable by at least one processor to perform a method of federated machine learning, the method comprising:

transmitting a current global machine learning model to each of a plurality of data sources;

receiving a plurality of training updates from the plurality of data sources, respectively, each of the plurality of training updates being generated by the respective data source in response to the global machine learning model received; and

updating the current global machine learning model based on the plurality of training updates received and a plurality of data quality parameters associated with the plurality of data sources, respectively, to generate an updated global machine learning model.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a flow diagram of a method of federated machine learning using at least one processor, according to various embodiments of the present invention;

FIG. 2 depicts a schematic block diagram of a server for federated machine learning, according to various embodiments of the present invention;

FIG. 3 depicts an example computer system which the server as described with respect to FIG. 2 may be embodied in, by way of an example only;

FIG. 4 depicts a schematic block diagram of a system for federated machine learning, according to various embodiments of the present invention;

FIG. 5 depicts an overview of a method of federated machine learning, according to various example embodiments of the present invention;

FIG. 6 depicts an example method (or algorithm) of federated machine learning, according to various example embodiments of the present invention;

FIG. 7A depicts three examples according to a first technique for determining a first data quality factor, according to various example embodiments of the present invention;

FIG. 7B depicts two examples according to a second technique for determining a second data quality factor, according to various example embodiments of the present invention; and

FIG. 8 depicts a flow diagram illustrating an example process for evaluating centrally hosted, federated, and weighted federated learning approaches or methods in an experiment, according to various example embodiments of the present invention; and

FIG. 9 depicts an overview of a process of assigning likelihood of mislabeling for noise simulation, according to various example embodiments of the present invention.

### DETAILED DESCRIPTION

Various embodiments of the present invention provide a method of federated machine learning, and a server thereof.

As mentioned in the background, recent works have developed decentralized federated learning approaches to train deep learning models across multiple data sources without sharing sensitive information. These existing federated learning approaches have had demonstrated successes, but may nevertheless suffer from inaccuracies and/or unreliability depending on the data sources on which they are trained. In particular, according to various embodiments of the present invention, it is identified that these existing federated learning approaches either assume that each of the multiple data sources offer the same quality of data (labelled data) or fail to take into account the different qualities of data amongst the multiple data sources, resulting in inaccuracies and/or unreliability.

For example and without limitation, according to various embodiments, it is noted that various applications in the domains of medical imaging, driver-assist systems, remote sensing devices and crowd-sourced social media systems exhibit high variability in data quality across data sources. In some cases, for example, the input data features are highly variable due to image artifacts, differences in acquisition parameters, or equipment standards. In other cases, for example, because labels can often correspond to disparate expert opinions and judgments and be influenced by human error, the label quality may be variable, and the ground truth label may be difficult to define.

It is known in the art that labelled data may comprise features (or data features) and labels. For example and without limitation, in machine learning, features may refer to information in data that may have predictive power (e.g., facilitates prediction or predictive capability) for a prediction task, and may also be referred to as input data features. Labels may refer to the ground-truth outcome for the prediction task with respect to the associated features. With regard to feature quality, for example, all devices and acquisition conditions may not be able to produce equal quality images. By way of an example, a medical magnetic resonance (MR) image scanner operating at 1 T vs. 3 T may lead to very different feature quality for specific diagnostic needs. Further, with regards to label quality, all experts may not be equal in their knowledge, skills, experience, judgment, specialization, and reputation. Further, focus and fatigue levels may vary amongst data annotators, introducing disparity in the quality of the labels. For example, in the medical imaging domain, in evaluations performed on the same samples, experts may often disagree with their colleagues and even with themselves (at a later time). In some complex applications, it may even be expected for experts to come to different assessments and the discordance rates between experts may be very high. As such, various embodiments of the present invention identified that the label quality may vary significantly across data sources, experts, and reads.

In this regard, various embodiments of the present invention identify that existing efforts to perform federated learning may be highly limited in their ability to account for and adapt to differences in data quality and distribution across multiple data sources. Accordingly, various embodiments relate to efforts in modelling data uncertainty (e.g., including label uncertainty and/or feature uncertainty), weakly supervised learning, federated learning, and multi-view learning.

In systems which do not use machine learning, data privacy concerns collecting consumer/enterprise data and future use of such data. Data is collected when the system is being used. On the other hand, in systems which use machine learning, in addition to data privacy concerns when system is being used (i.e., during inference time), there are data privacy concerns when data is used for training machine learning models. Techniques such as Homomorphic encryption can be used to protect privacy during inference time.

Conventional supervised machine learning algorithms need training data to be centralized on one machine or in a data-center. It is generally believed in the machine learning community that more labelled data will result in better models. However, centralizing data in one machine or data-center may not be desirable or even feasible. In 2017, federated learning (FL) (which may also be referred to as federated machine learning) was introduced whereby it is possible to learn high-quality models without centralizing data. The use-case was text-phrase prediction and then extended to include secure aggregation. Federated learning is also seen as an important data-privacy technique in the medical domain. However, compared to applications where individual data generators (sources) generally generate data that is of sufficiently good quality for the learning task at hand, in medical domain, various embodiments of the present invention identified problems associated with differences (e.g., significant variation) in the quality of data amongst different data sources.

For machine learning purposes, labelled data may comprise features (or data feature) and labels. For example and without limitation, in machine learning, features may refer to information in data that may have predictive power (e.g., facilitates prediction or predictive capability) for a prediction task, and may also be referred to as input data features. Labels may refer to the ground-truth outcome for the prediction task with respect to the associated features. Supervised machine learning seeks to learn the functional mapping between features and labels. Typically, supervised learning requires creation of large labelled data-sets with both high quality features and labels. However, creating large labelled data-sets is expensive, time consuming and highly consequential. In this regard, machine learning models are sensitive to the quality of data—both the quality of features and labels.

In many applications, when data-sets are created, data engineers may (a) pre-process the data to clean up the feature space; and (b) collect multiple labels for each sample in the data-set, and aggregate labels (e.g., majority voting) to mitigate noise. In some cases, labels may be assigned automatically and in others, “crowdsourcing” (e.g., via platforms such as Amazon's Mechanical Turk) may be used as a means to create and enhance the quality of data. However, various embodiments of the present invention identified that such an approach is often infeasible for applications where data generation requires specialized devices, domain knowledge and/or judgment (e.g., applications in the medical domain). In such cases, feature quality may suffer in certain acquisition conditions. Furthermore, as labels may be assigned based on human expert judgment call, there may often be significant variability amongst experts resulting in label quality variations.

For feature quality variations, much research has focused on denoising or missing data imputation. However, such conventional approaches may not be able to uniformize feature quality in the federated setting. For label quality variations, recent research has focused on modelling the labellers. However, such studies have focused on modelling label noise, when it is feasible to obtain multiple human to label a sample in the data-set. In the medical domain, especially in the federated setting, it may not be realistic to assume that a sample will have multiple labellers.

Accordingly, various embodiments of the present invention provide a method of federated machine learning, and a system thereof, that seek to overcome, or at least ameliorate, one or more of the deficiencies in existing federated machine learning approaches or methods, such as but not limited to, improving the accuracy and/or reliability of federated machine learning. It is against this background that the present invention has been developed.

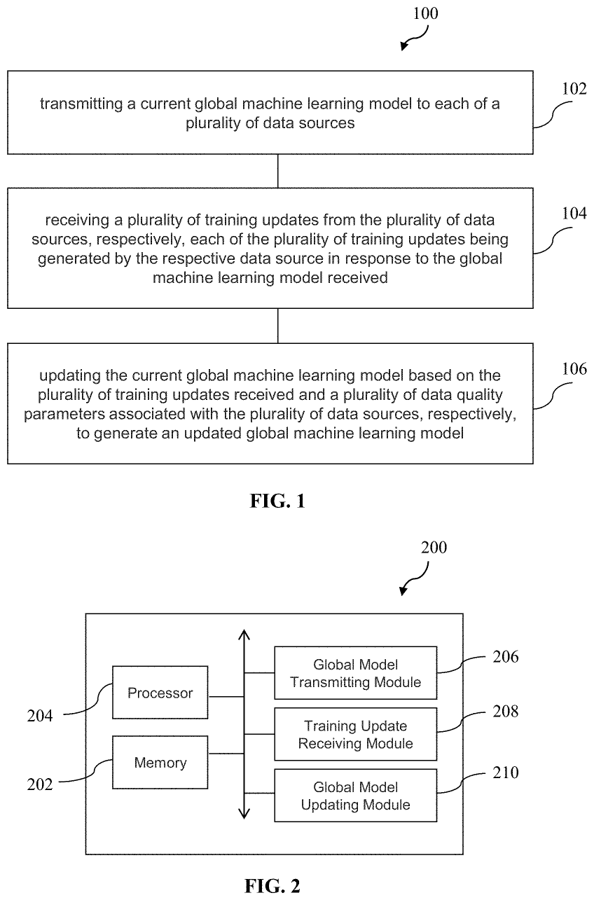

FIG. 1 depicts a flow diagram of a method 100 of federated machine learning using at least one processor, according to various embodiments of the present invention. The method 100 comprises transmitting (at 102) a current global machine learning model to each of a plurality of data sources; receiving (at 104) a plurality of training updates from the plurality of data sources, respectively, each of the plurality of training updates being generated by the respective data source in response to the global machine learning model received; and updating (at 106) the current global machine learning model based on the plurality of training updates received and a plurality of data quality parameters associated with the plurality of data sources, respectively, to generate an updated global machine learning model.

It can be understood by a person skilled in the art that federated machine learning is a distributed machine learning technique which enables training on decentralized data (e.g., a large corpus of decentralized data) residing on a plurality of data sources. In various embodiments, the method 100 may be performed by a server (e.g., may be referred to as a central server or an aggregator server) configured to provide or coordinate (e.g., implement/execute and/or control/manage) federated machine learning as a cloud-based distributed service (e.g., a federated learning plan), and the plurality of data sources may be referred to as participants (e.g., a federated learning population) in the federated machine learning provided by the server. For example, the plurality of data sources may each be embodied as a device or system having data (labelled data for training) stored therein, such as but not limited to, a storage system (e.g., for an enterprise or an organization, such as a local data storage server) or a storage device (e.g., for an individual, such as a mobile phone, a tablet, a portable computer and so on). Accordingly, the data source may also be referred to a local data source having stored therein local data (labelled data).

In relation to 102, a global machine learning model may refer to a machine learning model configured as desired to be trained based on data residing in or stored by a plurality of data sources, that is, based on decentralized data, for a particular desirable practical application, such as a classification task. In various embodiments, transmitting a current global machine learning model may include transmitting a current global model state (e.g., including current global model parameters) as a federated learning checkpoint. For example, the model architecture, initial weights and hyper parameter used on training the global machine learning model may be set uniformly across all participating data sources. By way of examples only and without limitations, examples of the model architecture used for an image classification task are Resnet, InceptionV3, DenseNet, and so on. In various embodiments, transmission from each participating data source for updating the global machine learning model at the server may only include the updated weight from the locally trained machine learning model at the participating data source or may include the whole locally trained machine learning model with the model states and parameters.

In relation to 104, to generate the training update, the data source may train the current global machine learning model locally based on labelled data stored by the data source. It can be understood by a person skilled in the art that any training technique known in the art as desired or as appropriate may be applied to train a machine learning model based on labelled data, and thus need not be described in detail herein for conciseness.

In relation to 106, each training update received may be modified or adjusted (e.g., weighted) based on the data quality parameter associated with the corresponding data source (i.e., the data source which the training update is received from).

In various embodiments, the method 100 of federated machine learning is performed iteratively in a plurality of rounds, each round performing the above-mentioned transmitting (at 102) the current global machine learning model to each of the plurality of data sources, the above-mentioned receiving (at 104) the plurality of training updates from the plurality of data sources, and the above-mentioned updating (at 106) the current global machine learning model based on the plurality of training updates received. In various embodiments, the number of rounds in the iteration may be predetermined or may continue (i.e., perform a further round) until a predetermined condition is met (e.g., until a loss function converges).

It will be appreciated by a person skilled in the art that the method 100 is not limited to the order of the steps as shown in FIG. 1, and the steps may be performed in any order suitable or appropriate for the same or similar outcome. As an example, in a current round, the current global machine learning model may first be updated based on the plurality of training updates received from the plurality of data sources in an immediately previous round, and the updated global machine learning model may then serve as a current (new current) global machine learning model for transmitting to each of the plurality of data sources in the current round.

Accordingly, various embodiments of the present invention advantageously identify problem(s) associated with different qualities of data (labelled data) amongst multiple data sources in relation to federated machine learning, and advantageously provide technical solution(s) which take into account the different qualities of data amongst multiple data sources in performing federated machine learning for improving the accuracy and/or reliability. In particular, according to various embodiments of the present invention, for each of the plurality of data sources, a data quality parameter is obtained and then utilized to modify or adjust (e.g., weight) the training update received from the corresponding data source when updating the current global machine learning model.

In various embodiments, each of the plurality of training updates is generated by the respective data source based on the global machine learning model received and labelled data stored by the respective data source. In this regard, the respective data source may train or update the global machine learning model received based on labelled data stored by the respective data source to generate a local machine learning model.

In various embodiments, each of the plurality of training updates comprises a difference between the current global machine learning model and the local machine learning model trained by the respective data source based on the current global machine learning model and labelled data stored by the respective data source.

In various embodiments, the above-mentioned updating (at 102) the current global machine learning model comprises determining a weighted average of the plurality of training updates based on the plurality of data quality parameters associated with the plurality of data sources, respectively. In this regard, each of the plurality of training updates is weighted based on the data quality parameter (e.g., data quality measure or index) associated with the corresponding data source.

In various embodiments, the labelled data stored by the respective data source comprises features and labels, and the data quality parameter associated with the respective data source comprises at least one of a feature quality parameter associated with the features and a label quality parameter associated with the labels. In this regard, the feature quality parameter provides a measure or an indication of the quality of the features stored by the data source, and the label quality parameter provides a measure or an indication of the quality of the labels stored by the data source.

In various embodiments, one or more of the plurality of data quality parameters are each based on at least one of a first data quality factor, a second data quality factor, and a third data quality factor. In this regard, the first data quality factor relates to a quality of the corresponding data source, the second data quality factor relates to a quality of labelled data stored by the corresponding data source, and the third data quality factor relates to a statistical derivation of data uncertainty (e.g., including label uncertainty and/or feature uncertainty). In various embodiments, each of the plurality of data quality parameters is based on at least one of a first data quality factor, a second data quality factor, and a third data quality factor.

In various embodiments, the first data quality factor is based on at least one of a reputation level (e.g., reputation score) associated with the data source, a competence level (e.g., competence score) of one or more data annotators of the labelled data stored by the corresponding data source, and a method value (e.g., method score) associated with a type of annotation method used to produce the labelled data stored by the corresponding data source. In various embodiments, each of the above-mentioned parameters (reputation level, competence level and method value) may be expressed as a numerical value, such as in a range from 0 to 1. In this regard, the first data quality factor based on multiple parameters may then be determined by multiplying the above-mentioned parameters (numerical values) together to obtain a first data quality factor value.

In various embodiments, the features of the labelled data are related to images (i.e., features of images), and the second data quality factor is based on at least one of image acquisition characteristics and a level of image artifacts in the images. For example and without limitation, the image acquisition characteristics may include an equipment value (e.g., equipment score) and an acquisition protocol (e.g., acquisition protocol score). For example and without limitation, image artifacts may include motion artifacts in the images. Similarly, each of the above-mentioned parameters (the image acquisition characteristics and the level of image artifacts) may be expressed as a numerical value, such as in a range from 0 to 1. Similarly, the second data quality factor based on multiple parameters may then be determined by multiplying the above-mentioned parameters (numerical values) together to obtain a second data quality factor value.

In various embodiments, the third data quality factor may be based on statistical properties of the labels in relation to the prediction task at hand, which may include mathematical estimation of the data quality index during local training at each data source. For example, this approach employs a Bayesian neural network during model training to estimate the data quality index based on a probabilistic interpretation of the model. The obtained data quality index may then correspond to the third quality factor.

In various embodiments, the method 100 further comprises: binning multiple data sources into a plurality of quality ranges; and selecting the plurality of data sources from multiple data sources.

In various embodiments, the plurality of data quality parameters are a plurality of data quality indices.

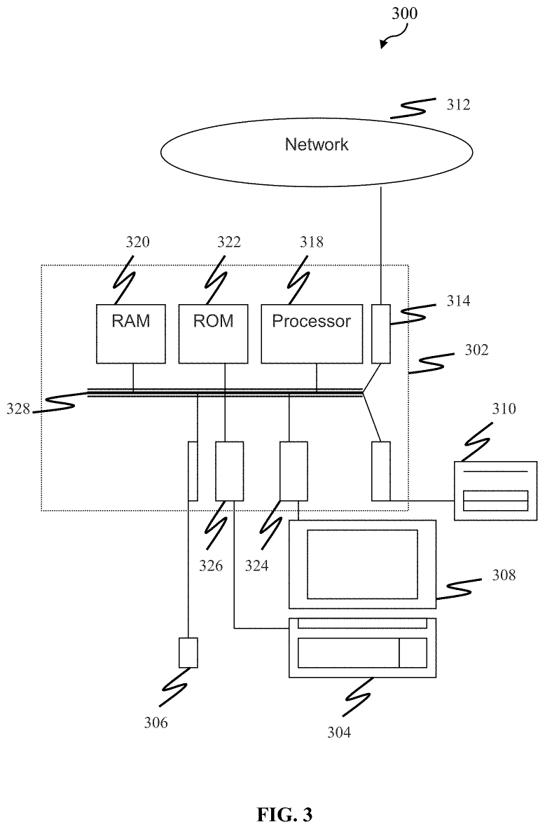

FIG. 2 depicts a schematic block diagram of a server 200 for federated machine learning according to various embodiments of the present invention, such as corresponding to the method 100 of federated machine learning as described hereinbefore according to various embodiments of the present invention. The server 200 comprises a memory 202, and at least one processor 204 communicatively coupled to the memory 202 and configured to: transmit a current global machine learning model to each of a plurality of data sources; receive a plurality of training updates from the plurality of data sources, respectively, each of the plurality of training updates being generated by the respective data source in response to the global machine learning model received; and update the current global machine learning model based on the plurality of training updates received and a plurality of data quality parameters associated with the plurality of data sources, respectively, to generate an updated global machine learning model.

It will be appreciated by a person skilled in the art that the at least one processor 204 may be configured to perform the required functions or operations through set(s) of instructions (e.g., software modules) executable by the at least one processor 204 to perform the required functions or operations. Accordingly, as shown in FIG. 2, the server 200 may comprise a global model transmitting module (or a global model transmitting circuit) 206 configured to transmit a current global machine learning model to each of a plurality of data sources; a training update receiving module (or a training update receiving circuit) 208 configured to receive a plurality of training updates from the plurality of data sources, respectively, each of the plurality of training updates being generated by the respective data source in response to the global machine learning model received; and a global model updating module (or a global model update circuit) 210 configured to update the current global machine learning model based on the plurality of training updates received and a plurality of data quality parameters associated with the plurality of data sources, respectively, to generate an updated global machine learning model.

It will be appreciated by a person skilled in the art that the above-mentioned modules are not necessarily separate modules, and one or more modules may be realized by or implemented as one functional module (e.g., a circuit or a software program) as desired or as appropriate without deviating from the scope of the present invention. For example, the global model transmitting module 206, the training update receiving module 208 and the global model updating module 210 may be realized (e.g., compiled together) as one executable software program (e.g., software application or simply referred to as an “app”), which for example may be stored in the memory 202 and executable by the at least one processor 204 to perform the functions/operations as described herein according to various embodiments. In various embodiments, the global model transmitting module 206 may be configured to transmit the current global machine learning model to each of the plurality of data sources via a wireless signal transmitter or a transceiver of the server 200. In various embodiments, the training update receiving module 208 may be configured to receive the plurality of training updates from the plurality of data sources, respectively, via a wireless signal receiver or a transceiver of the server 200.

In various embodiments, the server 200 corresponds to the method 100 as described hereinbefore with reference to FIG. 1, therefore, various functions or operations configured to be performed by the least one processor 204 may correspond to various steps of the method 100 described hereinbefore according to various embodiments, and thus need not be repeated with respect to the server 200 for clarity and conciseness. In other words, various embodiments described herein in context of the methods are analogously valid for the respective systems (e.g., the server 200), and vice versa.

For example, in various embodiments, the memory 202 may have stored therein the global model transmitting module 206, the training update receiving module 208 and the global model updating module 210, which respectively correspond to various steps of the method 100 as described hereinbefore according to various embodiments, which are executable by the at least one processor 204 to perform the corresponding functions/operations as described herein.

A computing system, a controller, a microcontroller or any other system providing a processing capability may be provided according to various embodiments in the present disclosure. Such a system may be taken to include one or more processors and one or more computer-readable storage mediums. For example, the server 200 described hereinbefore may include a processor (or controller) 204 and a computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “transmitting”, “receiving”, “updating”, “binning”, “selecting” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (e.g., which may also be embodied as a device or an apparatus) for performing the operations/functions of the methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. It will be appreciated by a person skilled in the art that various modules described herein (e.g., the global model transmitting module 206, the training update receiving module 208 and/or the global model updating module 210) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

In various embodiments, there is provided a computer program product, embodied in one or more computer-readable storage mediums (non-transitory computer-readable storage medium), comprising instructions (e.g., the global model transmitting module 206, the training update receiving module 208 and/or the global model updating module 210) executable by one or more computer processors to perform a method 100 of federated machine learning as described hereinbefore with reference to FIG. 1. Accordingly, various computer programs or modules described herein may be stored in a computer program product receivable by a system therein, such as the server 200 as shown in FIG. 2, for execution by at least one processor 204 of the server 200 to perform the required or desired functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

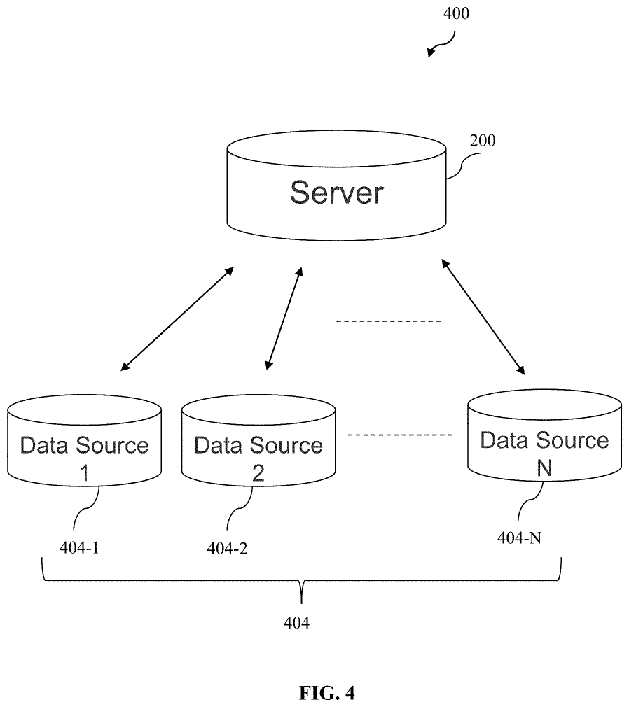

In various embodiments, the server 200 may be realized by any computer system (e.g., desktop or portable computer system) including at least one processor and a memory, such as a computer system 300 as schematically shown in FIG. 3 as an example only and without limitation. Various methods/steps or functional modules (e.g., the global model transmitting module 206, the training update receiving module 208 and/or the global model updating module 210) may be implemented as software, such as a computer program being executed within the computer system 300, and instructing the computer system 300 (in particular, one or more processors therein) to conduct the methods/functions of various embodiments described herein. The computer system 300 may comprise a computer module 302, input modules, such as a keyboard 304 and a mouse 306, and a plurality of output devices such as a display 308, and a printer 310. The computer module 302 may be connected to a computer network 312 via a suitable transceiver device 314, to enable access to e.g., the Internet or other network systems such as Local Area Network (LAN) or Wide Area Network (WAN). The computer module 302 in the example may include a processor 318 for executing various instructions, a Random Access Memory (RAM) 320 and a Read Only Memory (ROM) 322. The computer module 302 may also include a number of Input/Output (I/O) interfaces, for example I/O interface 324 to the display 308, and I/O interface 326 to the keyboard 304. The components of the computer module 302 typically communicate via an interconnected bus 328 and in a manner known to the person skilled in the relevant art.

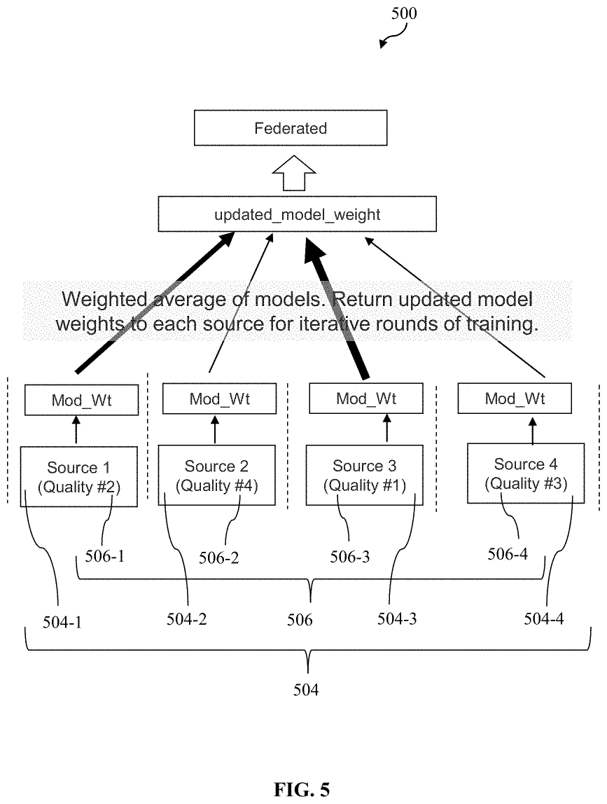

FIG. 4 depicts a schematic block diagram of a system 400 for federated machine learning according to various embodiments of the present invention. The system 400 comprises a server 200 and a plurality of data sources 404 (404-1, 404-2 to 404-N).

In various embodiments, the server 200 is configured for federated machine learning and may correspond to that as described hereinbefore with reference to FIG. 2. In particular, the server 200 comprises a global model transmitting module (or a global model transmitting circuit) 206 configured to: transmit a current global machine learning model to each of the plurality of data sources 404; a training update receiving module (or a training update receiving circuit) 208 configured to receive a plurality of training updates from the plurality of data sources 404, respectively, each of the plurality of training updates being generated by the respective data source in response to the global machine learning model received; and a global model updating module (or a global model update circuit) 210 configured to update the current global machine learning model based on the plurality of training updates received and a plurality of data quality parameters associated with the plurality of data sources 404, respectively, to generate an updated global machine learning model.

In various embodiments, each of the plurality of data sources 404 comprises a memory having stored therein labelled data (e.g., including features and labels) and at least one processor communicatively coupled to the memory and configured to: receive the current global machine learning model from the server 200; generate a training update in response to the global machine learning model received; and transmit the training update to the server 200. In relation to generating a training update, the data source may be configured to: train a local machine learning model based on the current global machine learning model received from the server 200 and the labelled data stored by the data source; and determine a difference between the current global machine learning model and the local machine learning model. As described hereinbefore, the plurality of data sources 404 may each be embodied as a device or system having data (labelled data for training) stored therein, such as but not limited to, a storage system (e.g., for an enterprise or an organization, such as a local data storage server) or a storage device (e.g., for an individual, such as a mobile phone, a tablet, a portable computer and so on).

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

According to various example embodiments, there is provided a scalable federated deep learning approach or method to handle variable data quality across multiple data sources. In this regard, the method weights the federation process based on the data quality for each data source. For illustration purpose and without limitation, an example overall framework according to various example embodiments will be described later below, along with three different example weighting strategies or techniques. Subsequently, evaluation experiments on computer aided detection and classification of diabetic retinopathy will be discussed as an example to show various technical advantages of the federated machine learning approach or method according to various example embodiments of the present invention. The federated machine learning method advantageously provides, for example, capabilities for a variety of real-world deployment scenarios that involve noisy and variable labelled data (e.g., including features and labels) across multiple data sources.

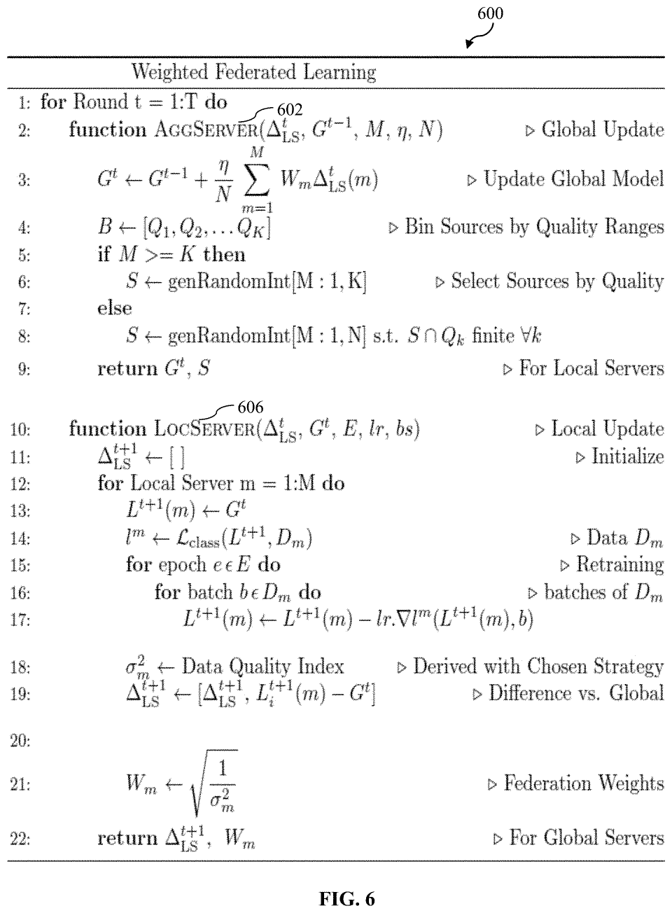

FIG. 5 depicts an overview of a method 500 of federated machine learning according to various example embodiments of the present invention. As shown in FIG. 5, a weighted federated machine learning method is provided based on the plurality of data quality parameters 506 (506-1, 506-2, 506-3, 506-4) associated with the plurality of data sources 504 (504-1, 504-2, 504-3, 504-4), respectively. In other words, the method 500 weights data sources differently based on their respective data quality parameters (e.g., data quality indices) 506.

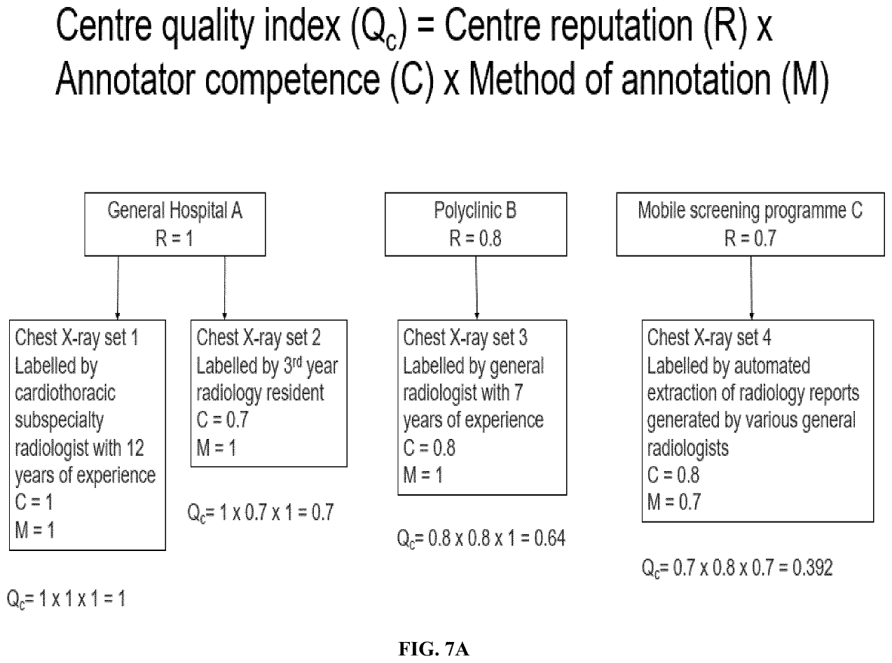

For illustration purpose only and without limitation, FIG. 6 shows an example method (or algorithm) 600 of federated machine learning according to various example embodiments of the present invention, and more particularly, a method of weighted federated machine learning. The example method 600 is based on iterative training and assumes N local data sources. In federated learning, training data may be retained at their native locations (data sources), and models (e.g., global and local models) are between an aggregator server (e.g., corresponding to the server 200 as described hereinbefore according to various embodiments) and distributed local servers (e.g., corresponding to the plurality of data sources 404 as described hereinbefore according to various embodiments). In each movement round, the federated learning may iteratively aggregate the local models (e.g., corresponding to the “local machine learning model” as described hereinbefore according to various embodiments) and updates a joint global model (e.g., corresponding to the “global machine learning model” as described hereinbefore according to various embodiments). In the example method 600 shown in FIG. 6, the following notations are adopted:
N: total number of local data sources (e.g., federated learning population) in the federated learning
M: number of sources being considered or utilized for federation at any round t
G^{t}: Global model at round t
L^{t}: Local model at round t
Δ_{LS}^{t}: differences between the local and global models at round t
S: list of indices of M sources selected for federation at any round t
Dₘ: local data stored by m^{th} local source (e.g., local server)
η: weighting factor for the federation
L_{class}(L,D): classification loss of model L tested on dataset D
l: classification loss function
E: local epochs
lr: learning rate
bs: batch size

The method 600 includes (a) an aggregator server function 602 configured to be performed by the aggregator server configured to provide or coordinate (e.g., implement/execute and/or control/manage) federated machine learning with respect to the local data sources (e.g., local servers in the example) in the federated learning population, and (b) a local data source function (e.g., local server function in the example) 606 configured to be performed by the respective local data sources selected by the aggregator server (selected to receive the current global machine learning model) for each round. The method 600 may be performed iteratively and includes, for each of a plurality of rounds in the iteration, performing the aggregator server function 602 (executing an instance thereof) at the aggregator server and the local data source function 606 (e.g., executing an instance thereof) at the respective local servers selected by the aggregator server. As described hereinbefore, the number of rounds in the iteration may be predetermined (e.g., 1 to T as shown in FIG. 6, where T is a predetermined number) or may continue (i.e., perform a further round) until a predetermined condition is met (e.g., until a loss function converges).

With respect to the server function 602, at each round t, the aggregator server may select a subset (e.g., a random subset) of m data sources (1 to M) from a set of data sources (1 to N), and sends to the selected subset of data sources (e.g., corresponding to “the plurality of data sources” as described hereinbefore according to various embodiments) the most up-to-date (i.e., current) global model G^{t}. In various example embodiments, prior to selecting the subset of data sources, the method 600 further comprises binning the set of data sources (1 to N) into a plurality of intervals (bins) of K quality ranges, and then selecting the subset of data sources from the set of data sources (binned in the plurality of intervals) for federation for the current round t. In other words, the selection of the subset of M data sources may be based on data sources having been binned into a plurality (e.g., K) of quality ranges, which advantageously accounts for the varying quality ranges amongst the data sources. In this regard, for example, various example embodiments may allow a random set of quality ranges to be represented in each iteration. This allows real-world variability to be captured in each iteration. For example, if the data sources are not binned into quality ranges, the algorithm may randomly select M of total N data sources, whereby all data sources may have the same quality level. Accordingly, the above-mentioned binning process advantageously helps to capture variability. The aggregator server may then receive a plurality of training updates (e.g., a difference Δ_{LS}^{t} in the example) from the selected subset of data sources, respectively (after the respective data source has generated the respective training update in response to the current global model received), and then update the current global model based on the plurality of training updates received and the plurality of data quality parameters (e.g., data quality indices σₘ² in the example) associated with the subset of data sources, respectively, to generate an updated global model, which then serves as a new current global model. In this regard, the aggregator server may perform a weighted average of the received training updates based on the plurality of data quality parameters to obtain a weighted average result and then adding the weighted average result to the current global model to obtain the updated global model.

In the example method 600, for each round t, the steps of receiving the plurality of training updates and updating the current global machine learning model may be performed based on the plurality of training updates received in the immediately previous round (i.e., round t−1). In this case, the current global model G^{t-1} is updated based on the plurality of training updates received and the plurality of data quality parameters associated with the subset of data sources (selected in the immediately previous round), respectively, to generate an updated global model G^{t} as a new current global model for the current round t, which may then then be transmitted to the selected subset of data sources. However, it will be appreciated that each round is not limited to the above steps being performed in the order as shown in FIG. 6. As an example, for each round, the current global model G^{t} may first be transmitted to selected subset of data sources, and subsequently, the plurality of training updates from the selected subset of data sources may then be received in response to the current global model G^{t} and the current global model G^{t} may then be updated based on the plurality of training updates received and the plurality of data quality parameters associated with the selected subset of data sources (selected in the current round), respectively, to generate an updated global model G^{t+1}, which may then serve as a new current global model for the next round t+1.

With respect to the local data source function 606, at each round t, each of the selected subset of data sources (m local data sources) may update the current global model received to a new local model L^{t+1}(m) by training on their private data, such as shown in FIG. 6 by way of example only and without limitation, and sends the difference Δ_{LS}^{t} between the current global model and the local model trained back to the aggregator server for updating the current global model at the aggregator server as described above.

In various example embodiments, the plurality of data quality parameters (e.g., data quality indices σₘ² in the example) associated with the plurality of data sources may be computed in the plurality of data sources, respectively, as federated weights (e.g., W), such as shown in FIG. 6 by way of example only and without limitation, and then the federation weights may sent to the aggregator server. In various other embodiments, the plurality of data quality parameters may be sent to the aggregator server and then the federated weights (corresponding to the plurality of data sources, respectively) may be computed in the aggregator server. Various other weighting approaches or techniques may be employed as desired or as appropriate without deviating from the scope of the present invention.

Accordingly, the example method 600 may include obtaining a data quality parameter (e.g., data quality index σₘ² in the example) for each selected local data source m and subsequently weighting of the training updates Δ_{LS}^{t} received from the individual local data sources in the global model update performed by the aggregator server. Specifically, the global model update step weights the average of the training updates Δ_{LS}^{t} received from the various data sources based on the data quality indices for each data source. Further, the selection of the M data sources may also be performed by binning the sources into K quality ranges, to account for the varying quality ranges amongst the data sources.

In various embodiments, the plurality of data quality parameters may be a plurality of data quality indices σₘ² associated with the plurality of data sources, respectively. By way of examples only and without limitation, three example techniques for deriving data quality parameters (e.g., data quality indices) based on human errors, annotator background, clinical considerations, and/or statistical (e.g., model-based) derivation of data uncertainty (e.g., data noise), namely, based on a first data quality factor, a second data quality factor, and a third data quality factor, will now be described below according to various example embodiments of the present invention.

### Annotator Background and Reliability Metrics (e.g., Corresponding to the “First Data Quality Factor” Described Hereinbefore)

In various example embodiments, a first technique relates to label quality (corresponding to label quality parameter) and includes assigning the label quality index based on a formulaic representation of the reliability of the annotators. Accordingly, the first data quality factor relates to a quality of the corresponding data source. In various example embodiments, the first data quality factor is based on at least one of a reputation level (e.g., reputation score) associated with the data source, a competence level (e.g., competence score) of one or more data annotators of the labelled data stored by the corresponding data source, and a method value (e.g., method score) associated with a type of annotation method used to produce the labelled data stored by the corresponding data source. By way of examples only and without limitation, for manual annotation, the first technique may consider the reputation of the institution that hires the annotators, the license grade, and the number of years of experience. In addition, the first technique may also take into account situational factors that may affect an annotator's performance, such as clinical load and fatigue. For example, the number of hours worked in the period leading to the annotation may be used as a proxy. The first technique may also adjust for the effect of prevalence on anomaly detection. For example, annotators who are presented with several normal images in a row may easily miss an abnormal image that shows up rarely. For semi-automated annotation, such as with automated processing of text reports, the first technique may additionally consider the prediction errors (e.g., owing to language complexity or ambiguity) in the label quality index.

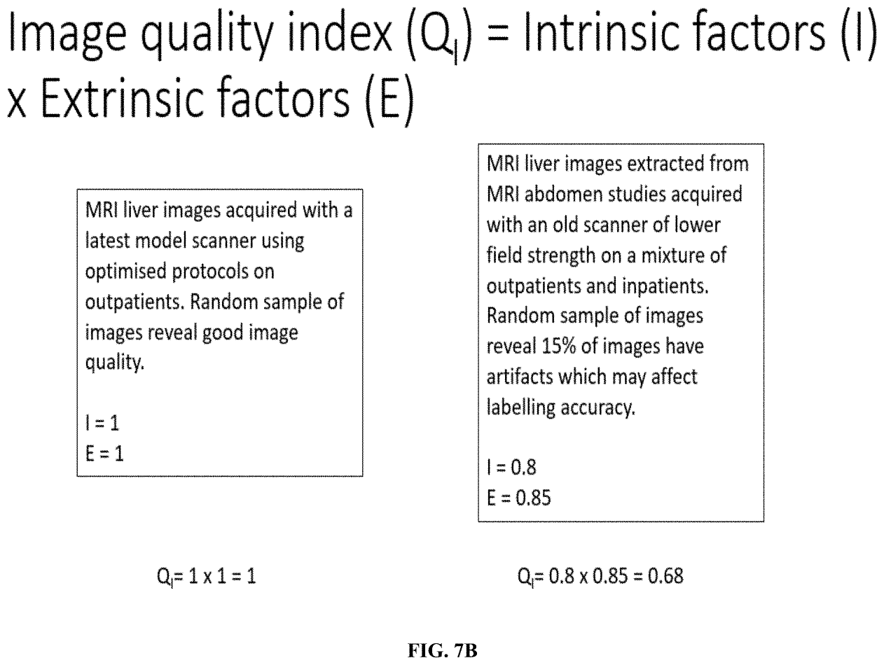

For illustration purpose only and without limitation, FIG. 7A shows three examples according to the first technique. For example, in the case of the data source belonging to a centre or an organization, the first data quality factor may be a centre quality index (Q_{c}) determined based on a centre reputation (R), an annotator competence (C), and the method of annotation (M). In this regard, the centre reputation (R), the annotator competence (C), and the method of annotation (M) may each be assigned (or graded) a value ranging from 0 to 1. For example, a value of 0 may correspond to the worst level and a value of 1 may correspond to the best level. In relation to the centre reputation (R), for example, the most reputable centre may be assigned a value of 1, less reputable centres may be assigned values between 0 and 1 accordingly. In various example embodiments, prospective centres having higher reputations than the centre assigned a value of 1 may be assigned values higher than 1 to reflect their expected superiority in data quality. In relation to the annotator competence (C), for example, annotators may be ranked by amount of experience and specialisation/subspecialisation relevant to the labelling task. The highest ranked annotator may be assigned a value of 1, and other annotators may be assigned values between 0 and 1 according to rank. Similarly, prospective annotators deemed more skillful than the highest ranked annotator may be assigned values higher than 1. In relation to method of annotation (M), manual annotation may be assumed to be the best and assigned a value of 1. The first data quality factor may then be determined by multiplying the values of the centre reputation (R), the annotator competence (C), and the method of annotation (M) together, such as illustrated in FIG. 7A.

### Clinical Considerations of Precursor Factors (e.g., Corresponding to the “Second Data Quality Factor” Described Hereinbefore)

In various example embodiments, the second technique relates to feature quality and label quality (corresponding to feature and label quality parameters) and includes assigning the data quality index based on a formulaic representation that considers intrinsic and extrinsic precursor factors, such as acquisition characteristics and image artifacts respectively. Accordingly, the second data quality factor relates to a quality of labelled data stored by the corresponding data source. In various embodiments, the features of the labelled data are related to images (i.e., features of images), and the second data quality factor is based on at least one of the image acquisition characteristics and the level of image artifacts in the images. By way of examples only and without limitation, the image acquisition characteristics may be defined based on specifications of the imaging equipment employed, parameter settings for image acquisition, and/or consistency of the patient history to requirements for high quality scans. For example, it may be possible that images acquired with different equipment or settings could be of lower quality (lower feature quality). Further, over or under exposure and/or presence of motion artifacts may make interpretation difficult for some images. In some cases, the lower quality image may lead to greater difficulties in interpretation (affecting label quality).

For illustration purpose only and without limitation, FIG. 7B shows two examples according to the second technique. For example, the second data quality factor may be an image quality index (Qi) determined based on intrinsic factors (I) and extrinsic factors (E). Similarly, the intrinsic factors (I) and the extrinsic factors (E) may each be assigned (or graded) a value ranging from 0 to 1 based on their predicted impact on image quality before being presented for labelling. In various example embodiments, the intrinsic factors (I) may include equipment capability (e.g., 3 T vs 1.5 T MRI scanner) and acquisition protocols (e.g., CT slice thickness). In various example embodiments, the extrinsic factors (E) may include operator variation (e.g., experience of radiographers) and patient variation (e.g., motion artifacts). In various example embodiments, for factors such as motion artifacts, a random sample may be obtained to estimate the level of motion artifacts (e.g., prevalence and extent) in a large dataset.

### Learned Data Quality Metrics (e.g., Corresponding to the “Third Data Quality Factor” Described Hereinbefore).

In various example embodiments, the third technique relates to feature quality and label quality (corresponding to feature and label quality parameters) and includes learning the data quality index during training. Accordingly, the third quality factor relates to a statistical (e.g., model-based) derivation of data uncertainty (e.g., includes label noise and/or feature noise). In the third technique, instead of using a classical CNN, a Bayesian neural network is used and a distribution over its weights is learned, and the loss function is rewritten or modified to include an uncertainty regularization term. With supervision of the classification task, the data quality index (capturing both feature quality and label quality) may be learned implicitly from the loss function. By way of example only and without limitation, one example technique for learning these indices are described in Kendall et al., “What uncertainties do we need in Bayesian deep learning for computer vision”, 31^{st} Conference on Neural Information Processing Systems, CA, USA, 2017, the content of which being hereby incorporated by reference in its entirety for all purposes. It will be appreciated that the present invention is not limited to this example technique for learning these indices and other technique(s) known in the art may instead be employed as desired or as appropriate for learning these indices. In other words, the data quality index may be gained from a probabilistic interpretation of the model, and can be computed efficiently during the training process. In particular, in various example embodiments, the Bayesian technique disclosed in the above-mentioned Kendall reference for predicting aleatoric uncertainty is utilized, which corresponds to data quality (capturing both feature quality and label quality), based on the following equation:

$${\hat{x}}_{i , t} = {f}_{i}^{W} + {σ}_{i}^{W} {ϵ}_{t} , \qquad Equation ( 1 )$$

$${ϵ}_{t} ∼ 𝒩 ( 0 , I )$$

$${ℒ}_{x} = {\sum }_{i} log \frac{1}{T} {\sum }_{t} exp ( {\hat{x}}_{i , t , c} - log {\sum }_{{c}^{′}} exp {\hat{x}}_{i , t , {c}^{′}} )$$

$$with {x}_{i , t , {c}^{′}} the {c}^{′} element in the logit vector {x}_{i , t} .$$

In the Equation (1) above, the Deep Learning model may be trained to learn to predict aleatoric uncertainty using modified loss function (e.g., Lₓ), for example, using Bayesian Categorical Cross-Entropy methods. Hence, for classification task, during the inference, the Bayesian deep learning model may have two outputs, namely, the softmax activation values and the input variance.

For illustration purpose and without limitation, experiments performed using the method of federated machine learning according to various example embodiments of the present invention will now be described to demonstrate the associated technical advantages.

### Evaluation

### Data

In an experiment, 88,702 colour digital retinal fundus images were obtained from the Kaggle Diabetic Retinopathy competition (Kaggle, diabetic retinopathy detection (data), 2015. Data retrieved from Kaggle, https://www.kaggle.com/c/diabetic-retinopathy-detection/data). This is a large set of high-resolution retinal images, which have been rated by licensed clinicians on a scale of 0 to 4, corresponding to normal, mild, moderate, severe, and proliferative retinopathy, respectively. Experiment performed according to various example embodiments focuses on binary classification of non-referrable (scale 0-1) and referable (scale 2-4) Diabetic Retinopathy, where the latter is when the severity scale is moderate or worse.

In the experiment, the raw datasets were resized, normalized, filtered, and preprocessed. The images were then randomly sampled into a training and validation set of 57,146 images and a test set of 8,790 images. From the training and validation set, four data splits or “data sources” were randomly generated with equal size and injected with different label noise to simulate four different quality levels.

### Experiment

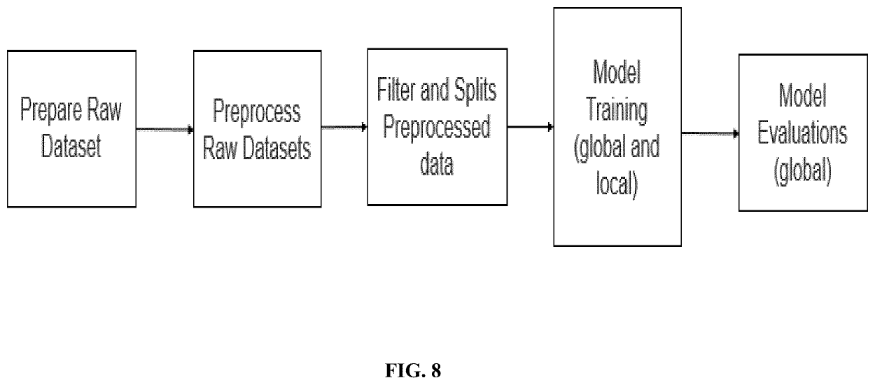

FIG. 8 depicts a flow diagram illustrating an example process for evaluating centrally hosted, federated, and weighted federated learning approaches or methods in an experiment. In each case, convolutional neural networks were trained using a standard pre-trained multi-layered convolutional network architecture for image classification. To compare with the baseline performance result, the method and hyper-parameters on the model training were chosen based on the original deep learning model development study for this dataset, as disclosed in V. Gulshan et al., “Development and validation of a deep learning algorithm for detection of diabetic retinopathy in retinal fundus photographs,” JAMA—Journal of the American Medical Association, vol. 316, no. 22, pp. 2402-2410, 2016.

In each case, training and evaluation were repeated five times on each data split and aggregate performance metrics were computed. For all federated learning experiments, the training for each local data source employs the same architecture and initialization, and the same number of epochs. For the weighted federated learning method according to example embodiments of the present invention, the three different strategies were employed to obtain three different sets of quality weights for the data sources.

### Simulated Label Noise

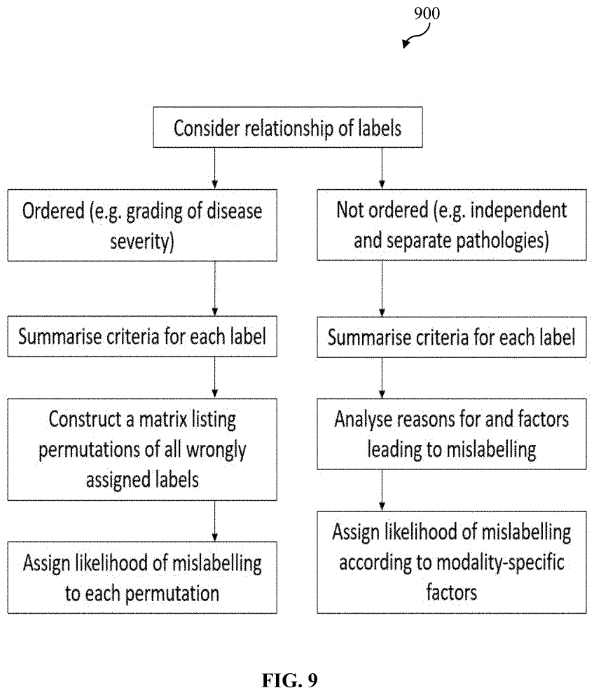

To evaluate the results against cases with ground truth of variable label quality, random or systematic noise was simulated into the labels for the Diabetic Retinopathy image datasets. These simulations were informed with clinical understanding of how mislabelling arises with respect to the specific type of data or images used. For example, domain expertise was employed to analyse the various ways and degrees to which mislabelling might occur in the real-world to simulate real-world quality variations. For the specific Diabetic Retinopathy use case, images graded for the presence and extent of eye disease may be mislabelled from time to time due to but not limited to the reasons outlined above. To model this realistically, the probability or likelihood of mislabelling was considered for all permutations of wrongly assigned labels as they are unlikely to occur with uniform frequency in real life. To generalize this evaluation logic for other medical imaging use cases, semi-automated simulation guidelines were developed that can enable automated derivation of meaningful thresholds for noise injection into the data. An overview of the above-described process 900 of assigning likelihood of mislabeling for noise simulation is provided in FIG. 9, according to various example embodiments of the present invention.

### Performance Results

Preliminary experiments were performed on data with native variations in label quality. For the model evaluation, various example embodiments use Area Under the Receiver Operating Characteristics (AUROC) and Area Under the Precision Recall Curve (AUPRC) metrics. AUROC is a performance metric for evaluating a model's ability to discriminate between cases (positive label) and non-cases (negative label), which is used extensively in medical research. AUPRC is another metric for evaluating a model trained with imbalance datasets, which is usually closer to the real use-case situation. To simulate different label quality, a simulated noise injected into the labels for less than 20% of the training data. In the experiments performed, it was observed that the weighted federated learning method according to various example embodiments of the present invention offers 3% (AUROC) and 6% (AUPRC) improvement over the centrally hosted and conventional federated learning methods on average. These results demonstrate the potential of weighted federated learning in adapting to label quality variations across sources.

In relation to practical applications, for example, use of federated learning to alleviate data privacy concerns (during learning) is likely to be widespread, given the excitement in research communities. However, it is found that the aspect or problem(s) of differing data quality across medical institutions has not been considered in conventional federated learning approaches. In contrast, various embodiments of the present invention advantageously provide technical solution(s) which take into account the different qualities of data amongst multiple data sources in performing federated machine learning for improving the accuracy and/or reliability. In various example embodiments, as described hereinbefore, a weighted federated averaging technique is employed to address data quality, and various techniques for assigning weights to address data quality have also been described.

Accordingly, various example embodiments of the present invention advantageously provide a weighted federated learning method for weighting data sources differently to account for data quality issues, which may for example be applied for medical imaging applications. Various example embodiments further provide automated weighting for reputation, precursor factors, and during learning, simulation of noise and robustness, and/or active learning for selection of sources based on data quality.

Accordingly, a scalable federated deep learning approach or method according to various embodiments of the present invention is provided to handle variable data quality across multiple data sources, which may be expanded to a variety of label noise conditions and to multiple modalities and diseases. For example, the method is relevant for several practical deployment scenarios that involve uncertain labels and require privacy.

By way of an example only and without limitation, in radiology, the ability to weight the network training process based on data quality may be useful in cases where labels are automatically extracted using natural language processing on unstructured radiology text reports. Further, the ability to consider class distributions in the data quality indices may also enable customization to class distributions within different sources. On a larger scale, the method of federated learning according to various example embodiments may be extended such that data quality adjustments may be customised to each centre, allowing investigation of the effects of centre-wide effects on federated learning models compared to other models which involve data pooling.

Although medical imaging applications have been described herein, it will be appreciated by a person skilled in the art that the present invention is not limited to medical imaging applications and may be implemented in any other application which uses federated learning, such as but not limited to, search browser auto-completion and cyber-security applications (e.g., malware detection).

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A method of federated machine learning using at least one processor, the method comprising:
transmitting a current global machine learning model to each of a plurality of data sources;
receiving a plurality of training updates from the plurality of data sources, respectively, each of the plurality of training updates being generated by the respective data source in response to the global machine learning model received; and
updating the current global machine learning model based on the plurality of training updates received and a plurality of data quality parameters associated with the plurality of data sources, respectively, to generate an updated global machine learning model.

2. The method according to claim 1, wherein each of the plurality of training updates is generated by the respective data source based on the global machine learning model received and labelled data stored by the respective data source.

3. The method according to claim 2, wherein each of the plurality of training updates comprises a difference between the current global machine learning model and a local machine learning model trained by the respective data source based on the current global machine learning model and labelled data stored by the respective data source.

4. The method according to claim 1, wherein said updating the current global machine learning model comprises determining a weighted average of the plurality of training updates based on the plurality of data quality parameters associated with the plurality of data sources, respectively.

5. The method according to claim 2, wherein the labelled data stored by the respective data source comprises features and labels, and the data quality parameter associated with the respective data source comprises at least one of a feature quality parameter associated with the features and a label quality parameter associated with the labels.

6. The method according to claim 5, wherein one or more of the plurality of data quality parameters are each based on at least one of a first data quality factor, a second data quality factor, and a third data quality factor, wherein the first data quality factor relates to a quality of the corresponding data source, the second data quality factor relates to a quality of labelled data stored by the corresponding data source, and the third data quality factor relates to a statistical derivation of data uncertainty.

7. The method according to claim 6, wherein the first data quality factor is based on at least one of a reputation level associated with the data source, a competence level of one or more data annotators of the labelled data stored by the corresponding data source, and a method value associated with a type of annotation method used to produce the labelled data stored by the corresponding data source, and wherein the features of the labelled data are related to images, and the second data quality factor is based on at least one of image acquisition characteristics and a level of image artifacts in the images.

8. The method according to claim 1, further comprising:
binning multiple data sources into a plurality of quality ranges; and
selecting the plurality of data sources from multiple data sources.

9. The method according to claim 1, wherein the plurality of data quality parameters are a plurality of data quality indices.

10. A server for federated machine learning comprising:
a memory; and
at least one processor communicatively coupled to the memory and configured to:
transmit a current global machine learning model to each of a plurality of data sources;
receive a plurality of training updates from the plurality of data sources, respectively, each of the plurality of training updates being generated by the respective data source in response to the global machine learning model received; and
update the current global machine learning model based on the plurality of training updates received and a plurality of data quality parameters associated with the plurality of data sources, respectively, to generate an updated global machine learning model.

11. The server according to claim 10, wherein each of the plurality of training updates is generated by the respective data source based on the global machine learning model received and labelled data stored by the respective data source.

12. The server according to claim 11, wherein each of the plurality of training updates comprises a difference between the current global machine learning model and a local machine learning model trained by the respective data source based on the current global machine learning model and labelled data stored by the respective data source.

13. The server according to claim 10, wherein said update the current global machine learning model comprises determining a weighted average of the plurality of training updates based on the plurality of data quality parameters associated with the plurality of data sources, respectively.

14. The server according to claim 11, wherein the labelled data stored by the respective data source comprises features and labels, and the data quality parameter associated with the respective data source comprises at least one of a feature quality parameter associated with the features and a label quality parameter associated with the labels

15. The server according to claim 14, wherein one or more of the plurality of data quality parameters are each based on at least one of a first data quality factor, a second data quality factor, and a third data quality factor, wherein the first data quality factor relates to a quality of the corresponding data source, the second data quality factor relates to a quality of labelled data stored by the corresponding data source, and the third data quality factor relates to a statistical derivation of data uncertainty.

16. The server according to claim 15, wherein the first data quality factor is based on at least one of a reputation level associated with the data source, a competence level of one or more data annotators of the labelled data stored by the corresponding data source, and a method value associated with a type of annotation method used to produce the labelled data stored by the corresponding data source, and wherein the features of the labelled data are related to images, and the second data quality factor is based on at least one of image acquisition characteristics and a level of image artifacts in the images.

17. The server according to claim 10, wherein the at least one processor is further configured to:
bin multiple data sources into a plurality of quality ranges; and
select the plurality of data sources from multiple data sources.

18. The server according to claim 10, wherein the plurality of data quality parameters are a plurality of data quality indices.

19. A computer program product, embodied in one or more non-transitory computer-readable storage mediums, comprising instructions executable by at least one processor to perform a method of federated machine learning, the method comprising:
transmitting a current global machine learning model to each of a plurality of data sources;
receiving a plurality of training updates from the plurality of data sources, respectively, each of the plurality of training updates being generated by the respective data source in response to the global machine learning model received; and
updating the current global machine learning model based on the plurality of training updates received and a plurality of data quality parameters associated with the plurality of data sources, respectively, to generate an updated global machine learning model.
